(19) United States
(12) Patent Application Publication
(10) Pub. No.: US 2021/0176964 A1
(43) Pub. Date: Jun. 17, 2021

(54) Wireless Fence for pets with Power-off Protection Measures and Operation Method thereof

(71) Applicant: SunSun Electronic Technology Inc., Boulder, CO (US)

(72) Inventor: Huixin MA, Boulder, CO (US)

(21) Appl. No.: 16/714,913

(22) Filed: Dec. 16, 2019

(51) Int. Cl. A01K 15/02; A01K 27/00

(52) U.S. Cl. CPC A01K 15/023; A01K 15/029; A01K 27/009; A01K 27/001

(57) ABSTRACT

A wireless fence with power-off protection measures, including a host and a collar composed of a receiving end and a strap that binds the receiving end to the neck of a pet. The receiving end receives a wireless signal transmitted by the host and warns or punishes the pet leaving a coverage range of a working signal of the host. When the host is powered off, a corresponding wireless instruction can be issued to make the receiving end stop working, so as not to warn or punish the pet. When the host is powered off, the receiving end can be standby or shut down, thereby avoiding pet injury and dog training inefficiency of the fence caused by misjudgment of pet behaviors from the receiving end that does not receive the working signal of the host in the case of host shutdown or power outage or failure.

### TECHNICAL FIELD

The disclosure relates to a wireless electronic fence for pets, and in particular, to a wireless fence with power-off protection measures, and an operation method thereof.

### BACKGROUND

Dogs are loyal friends of humans. Humans have a long history of breeding, training and using dogs. Since ancient times, people have lived with dogs day and night, and have established a deep relationship. Starting from the primitive society, after years of human breeding, domestication and training, dogs have learned special skills such as hunting, housekeeping, shepherding, people saving, chasing, drug enforcement, and garrisoning frontiers, help people to complete a number of complex and dangerous work, are sometimes irreplaceable, and become a human capable assistant. People's credit for working dogs is obvious to all. Pet dogs are also favored because they are petite, cute, smart, considerate, and loyal to their owners. Because of the above, dogs have entered more and more families as a member of the family. In order to protect the valuables at home from being damaged by dogs and to prevent the dogs from being lost or having an accident, it is usually necessary to limit the activity of pet dogs to a certain range. There are two main restriction methods. One is to use a rope to fasten a pet dog, and fixedly connect the other end of the rope to an object. The other is to use wooden boards or metal nets to construct a fence, so that the pet dog cannot run outside the fence. However, the use of the rope is too crude, and the construction of the fence is expensive.

In order to solve the above deficiencies, people have developed electronic fences for pets. The electronic fence for pets is mainly composed of a host installed fixedly and a receiving end worn on a pet dog. An electronic signal generated by the host is transmitted to the air through an antenna of the host without directing. Because the non-directional signal divergence appears as a point transmission, a signal wave expands outward as a sphere. Therefore, as the distance increases, the signal intensity decreases as a logarithmic function. After receiving the signal, a receiving end antenna of the receiving end analyzes the strength of the signal. When the pet dog leaves the host for more than a certain distance and the strength of the signal received by the receiving end is lower than a set warning activation threshold, a receiving end controller activates a warning function until the pet dog turns round. The receiving end may warn the pet dog in a variety of ways, including vibration, electric shocks, or ultrasound. In this way, an invisible and effective electronic fence for the pet dog is formed. The host may continuously generate electronic signals, and may also intermittently issue pulsed electronic signals according to a certain frequency. When the pet dog leaves the range of the electronic fence, the receiving end will prompt the pet dog to return to the range of the electronic fence as soon as possible, thereby achieving the same effect as the fence.

However, the receiving end determines a distance from the pet dog to the host according to the strength of the provided signal. Therefore, when the host is considered to be actively shut down or the signal disappears due to power outage or failure, the receiving end will accordingly determine that the pet dog has gone beyond the range of the electronic fence due to a long distance from the host, thereby forming a misjudgment. In particular, general electronic fences also punish pet dogs through strong stimulation means such as electric shocks. Once a misjudgment is formed, it will inevitably cause unnecessary injury to the pet dogs. For the pet dogs, there may be a confusion on behavior judgment, the pet dogs may have a stress reaction or confused cognition seriously, and the electronic fence will lose the effect of limiting the range of activity.

### SUMMARY

An objective of the disclosure is to provide a wireless fence for pets with power-off protection measures. Another objective of the disclosure is to provide an operation method of the wireless fence.

According to an aspect of the disclosure, a wireless fence for pets with power-off protection measures is provided. The wireless fence includes a host and a collar. The collar is composed of a receiving end and a strap that binds the receiving end to the neck of a pet. The receiving end receives a wireless signal transmitted by the host and warns or punishes the pet when the pet leaves a coverage range of a working signal of the host.

When the host is powered off, a corresponding wireless instruction is issued to make the receiving end stop working, so that the receiving end will not warn or punish the pet when the host is powered off.

The wireless fence adopting the above technical solution has power-off protection measures. When the host is powered off, the receiving end can be standby or shut down, thereby avoiding pet injury and dog training inefficiency of the fence caused by misjudgment of pet behaviors from the receiving end that does not receive the working signal of the host in the case of host shutdown or power outage or failure.

In some embodiments, the host is provided with a single-chip processing module, the single-chip processing module is connected to a power module and a wireless transmitting module separately, the power module is configured to provide a working current to the single-chip processing module, the wireless transmitting module is connected to an antenna and is configured to transmit the working signal to an external environment for reception by the receiving end, the host is further provided with a power-off detection module connected to the single-chip processing module, the power-off detection module is configured to detect a working state of the power module, when the power module powers off, the power-off detection module issues a failure signal from the antenna through the single-chip processing module and the wireless transmitting module, after receiving the failure signal, the receiving end partially or completely turns off the function of warning and punishing the pet, and the failure signal is different from the working signal issued through the antenna when the host normally works.

Further, the host is further provided with a backup power module, the backup power module being configured to provide, when the power module powers off, a backup current to allow the single-chip processing module and the wireless transmitting module to issue the failure signal from the antenna.

Specifically, the backup power module is a battery or a capacitor.

Preferably, the battery is a button battery, the button battery including an AG3 battery, an AG10 battery, an AG13 battery, a CR2032 battery, a CR2025 battery, a CR2016 battery, an SR44 battery, or an SR626 battery.

Preferably, the capacitor is connected to the single-chip processing module through a reverse charging module, and after the power module is disconnected, the capacitor provides a short-time steady DC to the single-chip processing module through the reverse charging module, for driving the single-chip processing module to perform the operation of issuing the failure signal.

In some other embodiments, the host is provided with a single-chip processing module, the single-chip processing module is connected to a power module and a wireless transmitting module separately, the power module is configured to provide a working current to the single-chip processing module, the wireless transmitting module is connected to an antenna and is configured to transmit the working signal to an external environment for reception by the receiving end, the host is further provided with a power switch, the power switch is connected to the single-chip processing module and configured to control the opening and closing of a power supply circuit of the power module, the power switch is capable of actively controlling an on-off state of the host, when the power switch issues an instruction of disconnecting the power module to the single-chip processing module, the single-chip processing module issues an off signal from the antenna and performs the operation of disconnecting the power module, and after receiving the off signal, the receiving end partially or completely turns off the function of warning and punishing the pet.

Specifically, when the power switch issues an instruction of disconnecting the power module to the single-chip processing module, the single-chip processing module respectively performs the following two actions:

(1) immediately issuing the off signal to the receiving end through the wireless transmitting module and the antenna to make the receiving end standby or shut down; and

(2) after a period of delay, disconnecting the power module, and shutting the host down.

Preferably, delay time for the single-chip processing module disconnecting the power module is 30-300 ms.

Specifically, the off signal is different from the working signal issued through the antenna when the host normally works.

Further, the receiving end is provided with a vibration motor, an electrode and an electric shock driving board, an output end of the electric shock driving board is connected to the electrode, the electrode is provided on the surface of a side of the receiving end near the neck of the pet, and the receiving end warns the pet through the vibration motor and provides a micro-current instant electric shock through the electrode to punish the pet.

According to an aspect of the disclosure, an operation method of a wireless fence for pets is provided for avoiding an electric shock injury to a pet when a signal disappears after a host of the wireless fence is powered off. Within a short period of time before or after the host is powered off, a shutdown signal is issued to a receiving end worn by the pet, so that the receiving end partially or completely turns off the function of warning and punishing the pet. Thus, stress reactions or confused cognitions of pet dogs are reduced, and an electronic fence is prevented from losing the effect of limiting the range of activity.

### BRIEF DESCRIPTION OF FIGURES

FIG. 1 is a diagram of the wireless fence for pets with power-off protection measures according to an embodiment of the disclosure.

FIG. 2 is a circuit diagram of the host shown in FIG. 1.

FIG. 3 is a circuit diagram of the collar shown in FIG. 1.

FIG. 4 is a circuit diagram of the host in the wireless fence for pets with power-off protection measures according to another embodiment of the disclosure.

### DETAILED DESCRIPTION

The disclosure is further described in details below with reference to the drawings.

### Example 1

The disclosure provides an operation method of a wireless fence, for avoiding an electric shock injury to a pet when a signal disappears after a host of the wireless fence is powered off. Within a short period of time before or after the host is powered off, a shutdown signal is issued to a receiving end worn by the pet, so that the receiving end partially or completely turns off the function of warning and punishing the pet. Thus, stress reactions or confused cognitions of pet dogs are reduced, and an electronic fence is prevented from losing the effect of limiting the range of activity.

The effect is achieved by the following device:

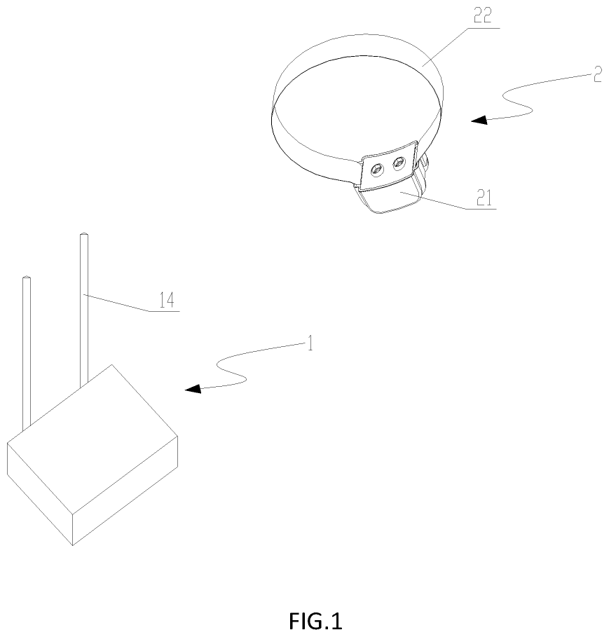

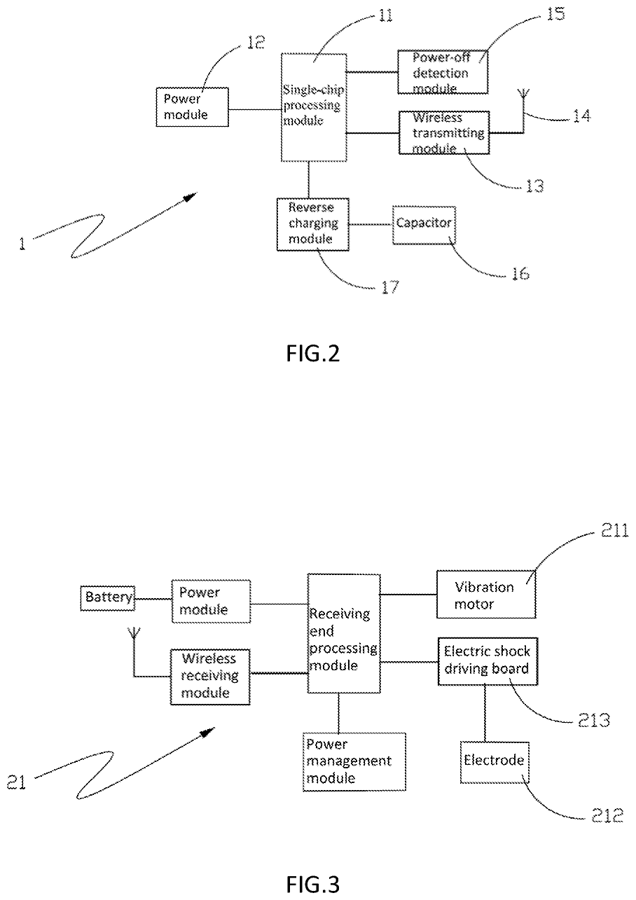

FIG. 1 to FIG. 2 chematically show a wireless fence with power-off protection measures according to an embodiment of the disclosure. As shown in the figures, the device includes a host 1 and a collar 2. The collar 2 is composed of a receiving end 21 and a strap 22 that binds the receiving end 21 to the neck of a pet. The receiving end 21 receives a wireless signal transmitted by the host 1 and warns or punishes the pet when the pet leaves a coverage range of a working signal of the host 1.

When the host 1 is powered off, a corresponding wireless instruction can be issued to make the receiving end 21 stop working, so that the receiving end 21 will not warn or punish the pet when the host 1 is powered off.

In this example, the host 1 is provided with a single-chip processing module 11.

The single-chip processing module 11 is connected to a power module 12 and a wireless transmitting module 13 separately.

The power module 12 is configured to provide a working current to the single-chip processing module 11.

The wireless transmitting module 13 is connected to an antenna 14 and is configured to transmit the working signal to an external environment for reception by the receiving end 21.

The host 1 is further provided with a power-off detection module 15 connected to the single-chip processing module 11.

The power-off detection module 15 is configured to detect a working state of the power module 12.

When the power module 12 powers off, the power-off detection module 15 issues a failure signal from the antenna 14 through the single-chip processing module 11 and the wireless transmitting module 13.

As shown in the figures, the receiving end 21 is provided with a vibration motor 211, an electrode 212 and an electric shock driving board 213, an output end of the electric shock driving board 213 is connected to the electrode 212, the electrode 212 is provided on the surface of a side of the receiving end near the neck of the pet, and the receiving end warns the pet through the vibration motor 211 and provides a micro-current instant electric shock through the electrode 212 to punish the pet.

After receiving the failure signal, the receiving end 21 partially or completely turns off the function of warning and punishing the pet.

In order to realize the separate and effective sending of the failure signal, the failure signal is different from the working signal issued through the antenna when the host 1 normally works.

The host 1 is further provided with a backup power module, the backup power module being configured to provide, when the power module 12 powers off, a backup current to allow the single-chip processing module 11 and the wireless transmitting module 13 to issue the failure signal from the antenna 14.

Specifically, the backup power module is a capacitor 16.

In this example, the capacitor 16 is connected to the single-chip processing module 11 through a reverse charging module 17, and after the power module 12 is disconnected, the capacitor 16 provides a short-time steady DC to the single-chip processing module 11 through the reverse charging module 17, for driving the single-chip processing module 11 to perform the operation of issuing the failure signal.

In other examples, the backup power module may also be a battery, including a button battery such as an AG3 battery, an AG10 battery, an AG13 battery, a CR2032 battery, a CR2025 battery, a CR2016 battery, an SR44 battery, or an SR626 battery.

The wireless fence adopting the above technical solution has power-off protection measures. When the host is powered off, the receiving end can be standby or shut down, thereby avoiding pet injury and dog training inefficiency of the fence caused by misjudgment of pet behaviors from the receiving end that does not receive the working signal of the host in the case of host shutdown or power outage or failure.

### Example 2

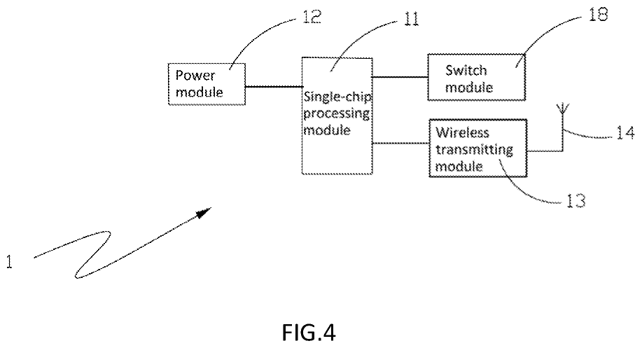

FIG. 4 schematically show a wireless fence with power-off protection measures according to an embodiment of the disclosure. As shown in the figures, the difference from Example 1 is that the host 1 is provided with a power switch 18.

The power switch 18 is connected to the single-chip processing module 11 and configured to control the opening and closing of a power supply circuit of the power module 12, and the power switch 19 is capable of actively controlling an on-off state of the host 1.

When the power switch 18 issues an instruction of disconnecting the power module 12 to the single-chip processing module 11, the single-chip processing module 11 issues an off signal from the antenna 14 and performs the operation of disconnecting the power module 12, and after receiving the off signal, the receiving end 21 partially or completely turns off the function of warning and punishing the pet.

Specifically, when the power switch 18 issues an instruction of disconnecting the power module 12 to the single-chip processing module 11, the single-chip processing module 11 respectively performs the following two actions:

(1) Immediately issue the off signal to the receiving end 21 through the wireless transmitting module 13 and the antenna 14 to make the receiving end 21 standby or shut down.

(2) After a period of delay, disconnect the power module 12, and shut the host 1 down.

Preferably, delay time for the single-chip processing module 11 disconnecting the power module 12 is 30-300 ms.

Generally, the off signal is different from the working signal issued through the antenna 14 when the host 1 normally works.

What have been described above are only some embodiments of the disclosure. For those of ordinary skill in the art, without departing from the inventive concept of the disclosure, several modifications and improvements can be made, which all belong to the protection scope of the disclosure.

What is claimed is:

1. A wireless fence with power-off protection measures, comprising a host and a collar, wherein the collar is composed of a receiving end and a strap that binds the receiving end to the neck of a pet, and the receiving end receives a wireless signal transmitted by the host and warns or punishes the pet when the pet leaves a coverage range of a working signal of the host; and
when the host is powered off, a corresponding wireless instruction is issued to make the receiving end stop working, so that the receiving end does not warn or punish the pet when the host is powered off.

2. The wireless fence with power-off protection measures according to claim 1, wherein the host is provided with a single-chip processing module, the single-chip processing module is connected to a power module and a wireless transmitting module separately, the power module is configured to provide a working current to the single-chip processing module, the wireless transmitting module is connected to an antenna and is configured to transmit the working signal to an external environment for reception by the receiving end, the host is further provided with a power-off detection module connected to the single-chip processing module, the power-off detection module is configured to detect a working state of the power module, when the power module powers off, the power-off detection module issues a failure signal from the antenna through the single-chip processing module and the wireless transmitting module, and after receiving the failure signal, the receiving end partially or completely turns off the function of warning and punishing the pet.

3. The wireless fence with power-off protection measures according to claim 2, wherein the host is further provided with a backup power module, the backup power module being configured to provide, when the power module powers off, a backup current to allow the single-chip processing module and the wireless transmitting module to issue the failure signal from the antenna.

4. The wireless fence with power-off protection measures according to claim 3, wherein the backup power module is a battery or a capacitor.

5. The wireless fence with power-off protection measures according to claim 4, wherein the battery is a button battery, the button battery comprising an AG3 battery, an AG10 battery, an AG13 battery, a CR2032 battery, a CR2025 battery, a CR2016 battery, an SR44 battery, or an SR626 battery.

6. The wireless fence with power-off protection measures according to claim 4, wherein the capacitor is connected to the single-chip processing module through a reverse charging module, and after the power module is disconnected, the capacitor provides a short-time steady DC to the single-chip processing module through the reverse charging module, for driving the single-chip processing module to perform an operation of issuing the failure signal.

7. The wireless fence with power-off protection measures according to claim 1, wherein the host is provided with a single-chip processing module, the single-chip processing module is connected to a power module and a wireless transmitting module separately, the power module is configured to provide a working current to the single-chip processing module, the wireless transmitting module is connected to an antenna and is configured to transmit the working signal to an external environment for reception by the receiving end, the host is further provided with a power switch, the power switch is connected to the single-chip processing module and configured to control the opening and closing of a power supply circuit of the power module, the power switch is capable of actively controlling an on-off state of the host, when the power switch issues an instruction of disconnecting the power module to the single-chip processing module, the single-chip processing module issues an off signal from the antenna and performs the operation of disconnecting the power module, and after receiving the off signal, the receiving end partially or completely turns off the function of warning and punishing the pet.

8. The wireless fence with power-off protection measures according to claim 7, wherein when the power switch issues an instruction of disconnecting the power module to the single-chip processing module, the single-chip processing module respectively performs the following two actions:
(1) immediately issuing the off signal to the receiving end through the wireless transmitting module and the antenna to make the receiving end standby or shut down, the off signal being different from the working signal issued through the antenna when the host normally works; and
(2) after a period of delay, disconnecting the power module, and shutting the host down, delay time for the single-chip processing module disconnecting the power module being 30-300 MS.

9. The wireless fence with power-off protection measures according to claim 1, wherein the receiving end is provided with a vibration motor, an electrode and an electric shock driving board, an output end of the electric shock driving board is connected to the electrode, the electrode is provided on the surface of a side of the receiving end near the neck of the pet, and the receiving end warns the pet through the vibration motor and provides a micro-current instant electric shock through the electrode to punish the pet.

10. An operation method of a wireless fence, for avoiding an electric shock injury to a pet when a signal disappears after a host of the wireless fence is powered off, wherein within a short period of time before or after the host is powered off, a shutdown signal is issued to a receiving end worn by the pet, so that the receiving end partially or completely turns off the function of warning and punishing the pet.
